(19) United States
(12) Patent Application Publication
(10) Pub. No.: US 2025/0189771 A1
(43) Pub. Date: Jun. 12, 2025

(54) ZOOM LENS AND IMAGE PICKUP APPARATUS

(71) Applicant: CANON KABUSHIKI KAISHA, Tokyo (JP)

(72) Inventor: Yonghee LEE, Tochigi (JP)

(21) Appl. No.: 18/925,099

(22) Filed: Oct. 24, 2024

(30) Foreign Application Priority Data
Dec. 8, 2023 (JP) 2023-207367

(51) Int. Cl. G02B 15/14; G02B 15/167

(52) U.S. Cl. CPC G02B 15/145129; G02B 15/1461; G02B 15/167

(57) ABSTRACT

A zoom lens includes, in order from an object side to an image side, a first lens unit having positive refractive power that does not move during zooming, an intermediate group including at least three lens units that move during zooming, and a final lens unit having positive refractive power that does not move during zooming. A distance between adjacent lens units changes during zooming. The intermediate group includes at least one lens unit having negative refractive power. A lens unit having negative refractive power and closest to an object among the at least one lens unit having negative refractive power includes at least one negative lens. Predetermined inequalities are satisfied.

### BACKGROUND

### Technical Field

The present disclosure relates to a zoom lens for imaging.

### Description of Related Art

As a positive lead type zoom lens in which a lens unit having positive refractive power is disposed closest to the object, Japanese Patent Laid-Open Nos. 2019-039945 and 2021-032925 disclose zoom lenses including five or more lens units. Japanese Patent Laid-Open No. 2019-039945 discloses a zoom lens having a zoom ratio of about 23 times, and including, in order from the object side to the image side, a first lens unit having positive refractive power, a second lens unit having negative refractive power, a third lens unit having negative refractive power, a fourth lens unit having positive refractive power, and a fifth lens unit having positive refractive power. Japanese Patent Laid-Open No. 2021-032925 discloses a zoom lens having a zoom ratio of about 10 times, and including, in order from the object side to the image side, a first lens unit having positive refractive power, a second lens unit having negative refractive power, a third lens unit having positive refractive power, a fourth lens unit having positive refractive power, and a fifth lens unit having positive refractive power.

### SUMMARY

A zoom lens according to one aspect of the disclosure includes, in order from an object side to an image side, a first lens unit having positive refractive power that does not move during zooming, an intermediate group including at least three lens units that move during zooming, and a final lens unit having positive refractive power that does not move during zooming. A distance between adjacent lens units changes during zooming. The intermediate group includes at least one lens unit having negative refractive power. A lens unit having negative refractive power and closest to an object among the at least one lens unit having negative refractive power includes at least one negative lens. The following inequalities are satisfied:

$$2.02 \leq nn \leq 2.3$$

$$20. \leq vn \leq 40.$$

$$1.5 \leq f 1 / fw \leq 7.7$$

where nn is a refractive index for d-line of a negative lens closest to the object among the at least one negative lens, vn is an Abbe number based on the d-line of the negative lens closest to the object, fl is a focal length of the first lens unit, and fw is a focal length of the zoom lens at a wide-angle end. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a sectional view of a zoom lens according to Example 1 at a wide-angle end in an in-focus state at infinity.

FIG. 2A illustrates an aberration diagram of the zoom lens according to Example 1 at a wide-angle end in an in-focus state at infinity, and FIG. 2B illustrates an aberration diagram of the zoom lens according to Example 1 at a telephoto end in an in-focus state at infinity.

FIG. 3 illustrates a sectional view of a zoom lens according to Example 2 at a wide-angle end in an in-focus state at infinity.

FIG. 4A illustrates an aberration diagram of the zoom lens according to Example 2 at a wide-angle end in an in-focus state at infinity, and FIG. 4B illustrates an aberration diagram of the zoom lens according to Example 2 at a telephoto end in an in-focus state at infinity.

FIG. 5 illustrates a sectional view of a zoom lens according to Example 3 at a wide-angle end in an in-focus state at infinity.

FIG. 6A is an aberration diagram of the zoom lens according to Example 3 at a wide-angle end in an in-focus state at infinity, and FIG. 6B is an aberration diagram of the zoom lens according to Example 3 at a telephoto end in an in-focus state at infinity.

FIG. 7 is a sectional view of a zoom lens according to Example 4 at a wide-angle end in an in-focus state at infinity.

FIG. 8A is an aberration diagram of the zoom lens according to Example 4 at a wide-angle end in an in-focus state at infinity, and FIG. 8B is an aberration diagram of the zoom lens according to Example 4 at a telephoto end in an in-focus state at infinity.

FIG. 9 is a sectional view of a zoom lens according to Example 5 at a wide-angle end in an in-focus state at infinity.

FIG. 10A is an aberration diagram of the zoom lens according to Example 1 at a wide-angle end in an in-focus state at infinity, and FIG. 10B is an aberration diagram of the zoom lens according to Example 1 at a telephoto end in an in-focus state at infinity.

FIG. 11 is a sectional view of a zoom lens according to Example 6 at a wide-angle end in an in-focus state at infinity.

FIG. 12A is an aberration diagram of the zoom lens according to Example 6 at a wide-angle end in an in-focus state at infinity, and FIG. 12B is an aberration diagram of the zoom lens according to Example 6 at a telephoto end in an in-focus state at infinity.

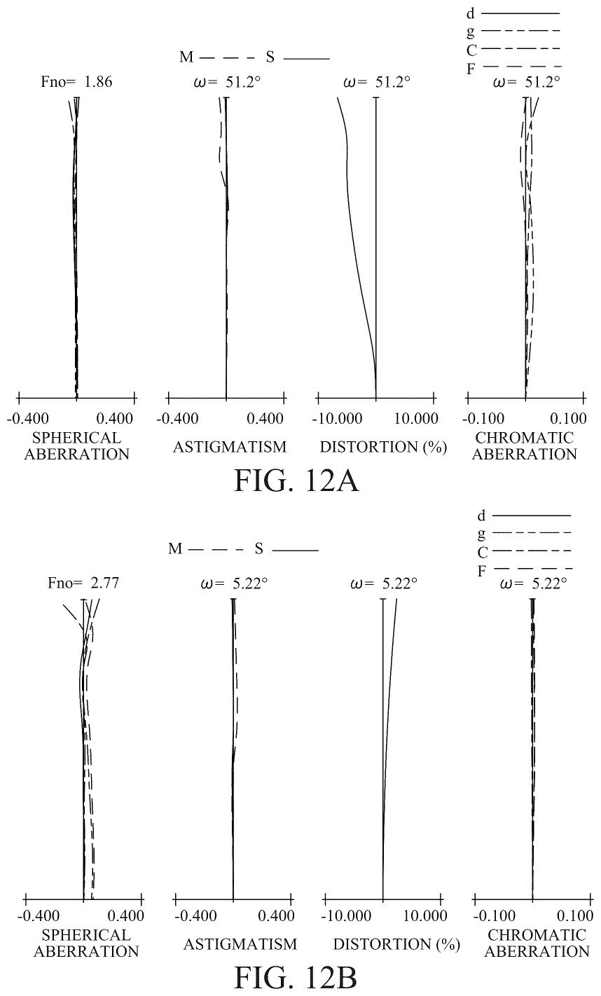

FIG. 13 illustrates an image pickup apparatus having the zoom lens according to any one of Examples 1 to 6.

### DETAILED DESCRIPTION

Referring now to the accompanying drawings, a description will be given of examples according to the disclosure. Prior to a detailed description according to Examples 1 to 6, matters common to each example will be described.

In a zoom lens, a lens unit is a group of one or more lenses that move together during magnification variation (zooming) between a wide-angle end and a telephoto end. That is, a distance between adjacent lens units changes during zooming. The lens unit may include an aperture stop (diaphragm). The wide-angle end and the telephoto end respectively indicate the zoom states of a maximum angle of view (shortest focal length) and a minimum angle of view (longest focal length) when the lens unit that moves during zooming is located at both ends of a mechanically or controllably movable range on the optical axis.

The zoom lens according to each example is used for cinema cameras, broadcasting cameras, video cameras, surveillance cameras, digital still cameras, and film-based cameras.

The zoom lens according to each example includes, in order from the object side to the image side, a first lens unit having positive refractive power, an intermediate group, and a final lens unit having positive refractive power. The first lens unit does not move during zooming. The intermediate group includes at least three lens units that move during zooming. The final lens unit does not move during zooming. The intermediate group includes at least one lens unit having negative refractive power. A lens unit having negative refractive power and closest to the object among the at least one lens unit having negative refractive power (referred to as an object-side negative lens unit hereinafter) V includes at least one negative lens.

The following inequalities (1) to (3) may be satisfied:

$$2.02 \leq nn \leq 2.3 \qquad ( 1 )$$

$$20. \leq vn \leq 40. \qquad ( 2 )$$

$$1.5 \leq f 1 / fw \leq 7.7 \qquad ( 3 )$$

where nn is a refractive index for the d-line of the negative lens closest to the object among the at least one negative lens included in the object-side negative lens unit V, vn is an Abbe number based on the d-line of the negative lens closest to the object, fl is a focal length of the first lens unit, and fw is a focal length of the zoom lens at the wide-angle end.

The Abbe number v based on the d-line is expressed as:

$$v = ( Nd - 1 ) / ( NF - NC )$$

where Nd, NF, and NC are refractive indices for the d-line (587.6 nm), F-line (486.1 nm), and C-line (656.3 nm) in the Fraunhofer line, respectively.

Inequalities (1) and (2) define proper characteristics of the glass material of the negative lens closest to the object among the object-side negative lens unit V. Using glass materials that satisfy inequalities (1) and (2) can achieve a refractive power arrangement that is beneficial to a wide angle and high magnification, and suppress various aberrations. In a case where nn becomes higher than the upper limit of inequality (1), the dispersion becomes too large for currently available glass materials, and it becomes difficult to correct chromatic aberration. In a case where nn becomes lower than the lower limit of inequality (1), it becomes difficult to achieve a wide angle and high magnification and to suppress various aberrations. In a case where nn becomes higher than the upper limit of inequality (2), the refractive index becomes too low for currently available glass materials, and it becomes difficult to achieve a wide angle and high magnification and to suppress various aberrations. In a case where nn becomes lower below the lower limit of inequality (2), the dispersion becomes too large, and it becomes difficult to correct chromatic aberration.

Inequality (3) defines a proper relationship between the first lens unit and the focal length at the wide-angle end of the zoom lens. Satisfying inequality (1) can achieve both the size reduction and high optical performance of the zoom lens. In a case where fl/fw becomes higher than the upper limit of inequality (1), the refractive power of the first lens unit decreases, the lens diameter of the first lens unit increases, and it becomes difficult to reduce the size of the zoom lens. In a case where fl/fw becomes lower than the lower limit of inequality (1), the refractive power of the first lens unit increases, the curvature of the lenses in the first lens unit increases, and it becomes difficult to achieve high optical performance.

Inequalities (1) to (3) may be replaced with inequalities (1a) to (3a) below:

$$2.03 \leq nn \leq 2 \text{.25} \qquad ( 1 a )$$

$$22. \leq vn \leq 35. \qquad ( 2 a )$$

$$1.7 \leq f 1 / fw \leq 7. 5 \qquad ( 3 a )$$

Inequalities (1) to (3) may be replaced with inequalities (1b) to (3b) below:

$$2.04 \leq nn \leq 2 \text{.20} \qquad ( 1 b )$$

$$24. \leq vn \leq 3 0. \qquad ( 2 b )$$

$$1.9 \leq f 1 / fw \leq 4. 0 \qquad ( 3 b )$$

Satisfying the above configurations and conditions can achieve a zoom lens that has a wide angle of view, a high zoom ratio, and high optical performance over the entire zoom range.

The zoom lens according to each example may satisfy at least one of the following inequalities (4) to (9) and configurations:

$$0.7 \leq fn / fV \leq 2. \qquad ( 4 )$$

$$0.63 \leq θ n + 0.00162 \times vn \leq 0.7 \qquad ( 5 )$$

$$60 \leq v \leq 100 \qquad ( 6 )$$

$$- 0.004 \leq ( θ {p}_{ave} - θ {n}_{ave} ) / ( {vp}_{ave} - {vn}_{ave} ) < 0. \qquad ( 7 )$$

$$- 5.5 \leq fV / fw \leq - 0.3 \qquad ( 8 )$$

$$0.2 \leq fw / IS \leq 2.2 \qquad ( 9 )$$

In inequalities (4) to (9), fn is a focal length of the negative lens closest to the object in the object-side negative lens unit V, fV is a focal length of the lens unit V, and θn is a partial dispersion ratio of the negative lens closest to the object in the lens unit V for the g-line and F-line. v is an Abbe number based on the d-line as a reference of at least one negative lens included in the object-side negative lens unit V. θpₐᵥₑ and vpₐᵥₑ are an average value of partial dispersion ratios for the g-line and F-line of all positive lenses included in the object-side negative lens unit V, and an average value of Abbe numbers based on the d-line as the reference of all positive lenses included in the object-side negative lens unit V, respectively. The partial dispersion ratio θ at the g-line and F-line is expressed as follows:

$$θ = ( Ng - NF ) / ( NF - NC )$$

where Ng is a refractive index for the g-line (435.8 nm) in the Fraunhofer line.

θnₐᵥₑ and vnₐᵥₑ are an average value of partial dispersion ratios for the g-line and F-line of all negative lenses included in the object-side negative lens unit V, and an average value of Abbe numbers for the d-line as the reference of all negative lenses included in the object-side negative lens unit V, respectively. IS is a diagonal length of the effective imaging surface of the image sensor configured to perform imaging through the zoom lens. The effective imaging surface is an area of the imaging surface of the image sensor that includes pixels that output signals that are used to generate image data.

Inequality (4) defines a proper relationship between the focal length of the negative lens closest to the object in the object-side negative lens unit V and the focal length of the object-side negative lens unit V. Satisfying inequality (4) can achieve a wide angle and suppress various aberrations. In a case where fn/fV becomes higher than the upper limit of inequality (4), the refractive power of the negative lens closest to the object decreases, and it becomes difficult to achieve a wide angle. In a case where fn/fV becomes lower than the lower limit of inequality (4), the refractive power of the negative lens closest to the object increases, and it becomes difficult to suppress various aberrations.

Inequality (5) illustrates a proper characteristic of the glass material of the negative lens closest to the object in the object-side negative lens unit V. Satisfying inequality (5) can suppress longitudinal and lateral chromatic aberrations. In a case where θn+0.00162×vn becomes higher than the upper limit of inequality (5), there is no existing glass material. In a case where θn+0.00162×vn becomes lower than the lower limit of inequality (5), the correction of chromatic aberration becomes insufficient.

Inequality (6) defines a proper characteristic of the glass material of the negative lens included in the object-side negative lens unit V. Satisfying inequality (6) can satisfactorily correct longitudinal chromatic aberration at the telephoto end. In a case where v becomes higher than the upper limit of inequality (6), there is no existing glass material. In a case where v becomes lower than the lower limit of inequality (6), it becomes difficult to satisfactorily correct the longitudinal chromatic aberration at the telephoto end.

Inequality (7) defines a proper achromatic condition for the object-side negative lens unit V. Satisfying inequality (7) can provide an achromatic effect that can satisfactorily correct longitudinal and lateral chromatic aberrations. In a case where (θpₐᵥₑ−θnₐᵥₑ)/(vpₐᵥₑ−vnₐᵥₑ) becomes higher than the upper limit of inequality (7), it becomes difficult to effectively correct longitudinal chromatic aberration. In a case where (θpₐᵥₑ−θnₐᵥₑ)/(vpₐᵥₑ−vnₐᵥₑ) becomes lower than the lower limit of inequality (7), it becomes difficult to effectively correct lateral chromatic aberration at the wide-angle side and the fluctuation of lateral chromatic aberration due to zooming.

Inequality (8) illustrates a proper relationship between the focal length of the object-side negative lens unit V and the focal length at the wide-angle end of the zoom lens. Satisfying inequality (8) can achieve a high zoom ratio and suppress various aberrations. In a case where fV/fw becomes higher than the upper limit of inequality (8), the refractive power of the object-side negative lens unit V becomes too weak, and the zoom lens becomes too large to achieve a high zoom ratio. In a case where fV/fw becomes lower than the lower limit of inequality (8), the refractive power of the object-side negative lens unit V becomes too strong, and it becomes difficult to suppress various aberrations.

Inequality (9) defines a proper relationship between the focal length at the wide-angle end of the zoom lens and the diagonal length of the effective imaging surface of the image sensor when the zoom lens according to each example is used for the image pickup apparatus. Satisfying inequality (9) can achieve a proper specification according to the image pickup apparatus. In a case where fw/IS becomes lower than the lower limit of inequality (9), the zoom lens becomes excessively wide-angle, and it becomes difficult to correct off-axis aberrations such as distortion and lateral chromatic aberration. In a case where fw/IS becomes higher than the upper limit of inequality (9), the zoom lens becomes excessively telephoto, and it becomes difficult to correct longitudinal chromatic aberration and other aberrations at the telephoto end.

Inequalities (4) to (9) may be replaced with inequalities (4a) to (9a) below:

$$0.8 \leq fn / fV \leq 1.8 \qquad ( 4 a )$$

$$0.63 \leq θ n + 0.00162 \times vn \leq 0.68 \qquad ( 5 a )$$

$$62 \leq v \leq 98 \qquad ( 6 a )$$

$$- 0.0038 \leq ( θ {p}_{ave} - θ {n}_{ave} ) / ( {vp}_{ave} - {vn}_{ave} ) \leq - 0.0005 \qquad ( 7 a )$$

$$- 5.2 \leq fV / fw \leq - 0.5 \qquad ( 8 a )$$

$$0.3 \leq fw / IS \leq 2.1 \qquad ( 9 a )$$

Inequalities (4) to (9) may be replaced with inequalities (4b) to (9b) below:

$$0.9 \leq fn / fV \leq 1.6 \qquad ( 4 b )$$

$$0.64 \leq θ n + 0.00162 \times vn \leq 0.66 \qquad ( 5 b )$$

$$64 \leq v \leq 96 \qquad ( 6 b )$$

$$- 0.0035 \leq ( θ {p}_{ave} - θ {n}_{ave} ) / ( {vp}_{ave} - {vn}_{ave} ) \leq - 0.001 \qquad ( 7 b )$$

$$- 4.9 \leq fV / fw \leq - 0.7 \qquad ( 8 b )$$

$$0.35 \leq fw / IS \leq 2. \qquad ( 9 b )$$

In each example, the negative lens closest to the object among at least one negative lens in the object-side negative lens unit V may be an aspheric lens. This configuration can easily suppress the fluctuation in distortion on the wide-angle side.

In each example, the object-side negative lens unit V may include at least four lenses. This configuration can easily suppress various aberrations, particularly fluctuations in off-axis aberrations due to zooming on the wide-angle side.

In each example, a part of the first lens unit (a focus subgroup) may move for focusing. This configuration can maintain a moving amount of the focus subgroup constant over the entire zoom range, and prevent fluctuations in zoom magnification along with focusing on an object at a close distance.

The zoom lens according to each example will be described in detail below. After the description according to Example 6, numerical examples 1 to 6 corresponding to Examples 1 to 6, respectively, will be illustrated.

### Example 1

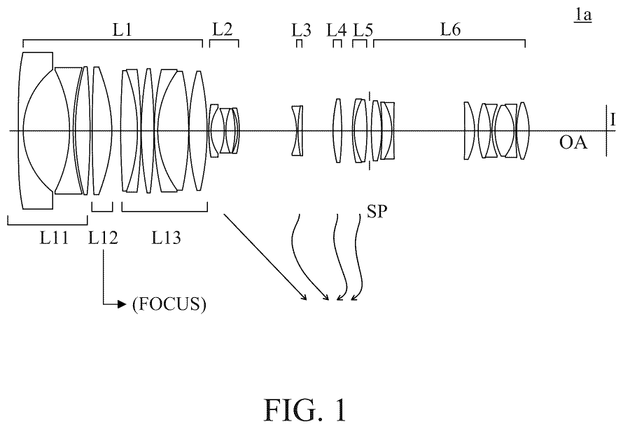

FIG. 1 illustrates a section of a zoom lens 1a according to Example 1 (numerical example 1) at a wide-angle end in a state where the lens is in focus on an object at infinity (hereinafter referred to as “in an in-focus state at infinity”). In this sectional view and in the sectional views of other examples described later, a left side is an object side (front side) and a right side is an image side (rear side). OA represents an optical axis and I represents an image plane. An imaging surface (light receiving surface) of an image sensor such as a CCD sensor or a CMOS sensor or a film surface (photosensitive surface) of a silver film is disposed on the image plane I.

The zoom lens 1a consists of, in order from the object side to the image side, a first lens unit L1 having positive refractive power, a second lens unit L2 having negative refractive power, a third lens unit L3 having negative refractive power, a fourth lens unit L4 having positive refractive power, a fifth lens unit L5 having positive refractive power, an aperture stop SP, and a sixth lens unit L6 having positive refractive power. The first lens unit L1 does not move during zooming, while the second, third, fourth and fifth lens units L2, L3, L4 and L5, which constitute the intermediate group, move during zooming. Arrows in FIG. 1 indicate moving loci of the lens units that move during zooming from the wide-angle end to the telephoto end, and this is similarly applicable to the sectional views of other examples described later. The sixth lens unit L6 is the final lens unit for imaging and does not move during zooming.

The first lens unit L1 includes, in order from the object side to the image side, a first sub-lens unit L11 having negative refractive power, a second sub-lens unit L12 having positive refractive power, and a third sub-lens unit L13 having positive refractive power. The second sub-lens unit L12 is a focus subgroup that moves to the image side during focusing from infinity to a close distance, as indicated by an arrow (FOCUS) in FIG. 1.

The second lens unit L2 corresponds to the object-side negative lens unit V, and moves to the image side as a variator during zooming from the wide-angle end to the telephoto end. The second lens unit L2 includes four lenses (two of which form a cemented lens), and the negative lens closest to the object is an aspherical lens. An optical unit such as an extender lens for focal length conversion may be inserted into the sixth lens unit L6.

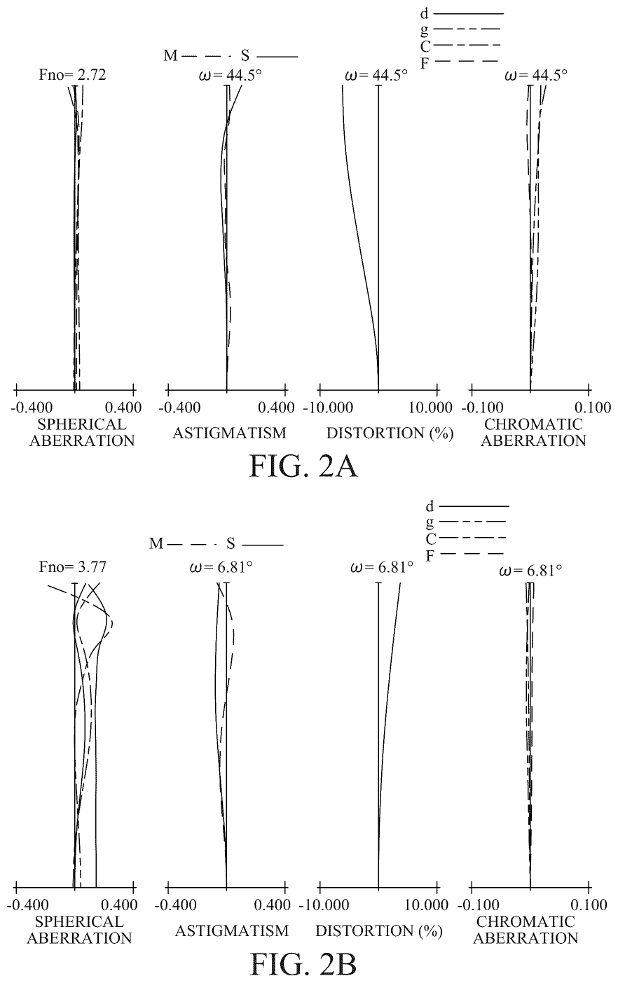

FIG. 2A illustrates a longitudinal aberration (spherical aberration, astigmatism, distortion, and chromatic aberration) of the zoom lens 1a at the wide-angle end in an in-focus state at infinity. FIG. 2B illustrates a longitudinal aberration of the zoom lens 1a at a telephoto end in an in-focus state at infinity. A solid line, alternate long and two short dashes line, alternate long and short dash line, and dashed line in the spherical aberration diagram illustrate spherical aberration amounts for the d-line, g-line, C-line, and F-line, respectively. Solid and dashed lines in the astigmatism diagram illustrate astigmatism amounts on a sagittal image plane (ΔS) and a meridional image plane (ΔM), respectively. The distortion diagram illustrates a distortion amount for the d-line. An alternate long and two short dashes line, alternate long and short dash line, and dashed line in the chromatic aberration diagram indicate lateral chromatic aberration amounts for the g-line, C-line, and F-line, respectively. The astigmatism and lateral chromatic aberration illustrate aberration amounts when the ray passing through the center of the light beam at the position of the aperture stop SP is set as a principal ray. ω is a paraxial half angle of view (°), and Fno is an F-number. The spherical aberration diagram is illustrated on a scale of 0.4 mm, the astigmatism diagram is illustrated on a scale of 0.4 mm, the distortion diagram is illustrated on a scale of 10%, and the chromatic aberration diagram is illustrated on a scale of 0.1 mm.

A description regarding the sectional view and longitudinal aberration diagram of the zoom lens according to this example is similarly applicable to the following examples.

### Example 2

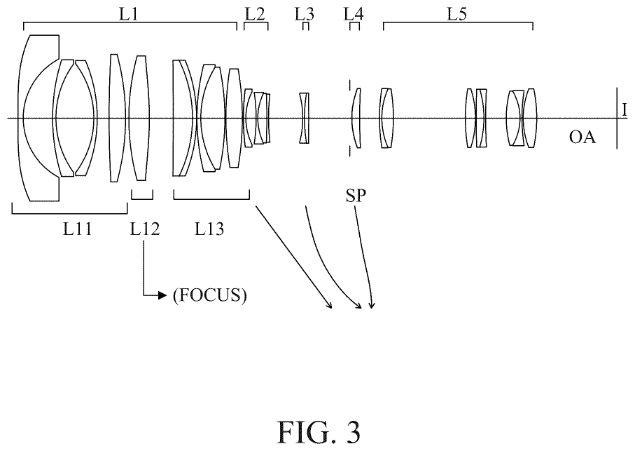

FIG. 3 illustrates a section of a zoom lens 1b according to Example 2 (numerical example 2) at a wide-angle end in an in-focus state at infinity.

The zoom lens 1b consists of, in order from the object side to the image side, a first lens unit L1 having positive refractive power, a second lens unit L2 having negative refractive power, a third lens unit L3 having negative refractive power, an aperture stop SP, a fourth lens unit L4 having positive refractive power, and a fifth lens unit L5 having positive refractive power. The first lens unit L1 does not move during zooming, while the second lens unit L2, the third lens unit L3, and the fourth lens unit L4, which constitute the intermediate group, do move during zooming. The fifth lens unit L5 is the final lens unit for imaging, and does not move during zooming.

The first lens unit L1 includes, in order from the object side to the image side, a first sub-lens unit L11 having negative refractive power, a second sub-lens unit L12 having positive refractive power, and a third sub-lens unit L13 having positive refractive power. The second sub-lens unit L12 is a focus subgroup that moves from the object side to the image side during focusing from infinity to a close distance, as indicated by an arrow (FOCUS) in FIG. 3.

The second lens unit L2 corresponds to the object-side negative lens unit V, and moves to the image side as a variator during zooming from the wide-angle end to the telephoto end. The second lens unit L2 includes four lenses (three of which form one cemented lens), and the negative lens closest to the object is an aspheric lens. The fourth lens unit L4 moves together with the aperture stop SP during zooming. An optical unit such as an extender lens may be inserted into the fifth lens unit L5.

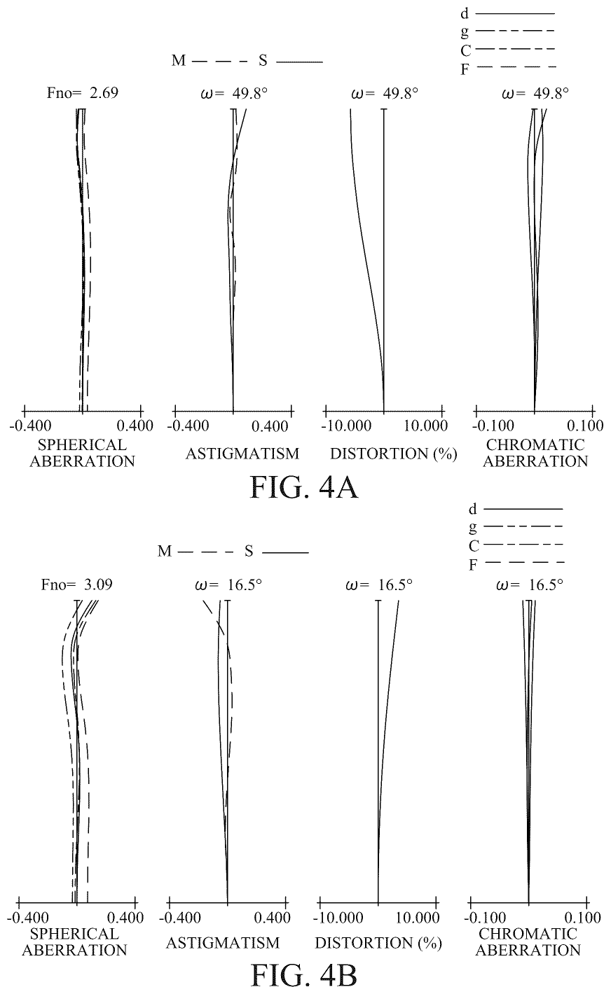

FIG. 4A illustrates a longitudinal aberration of zoom lens 1b at a wide-angle end in an in-focus state at infinity and, and FIG. 4B illustrates a longitudinal aberration of zoom lens 1b at a telephoto end in an in-focus state at infinity.

### Example 3

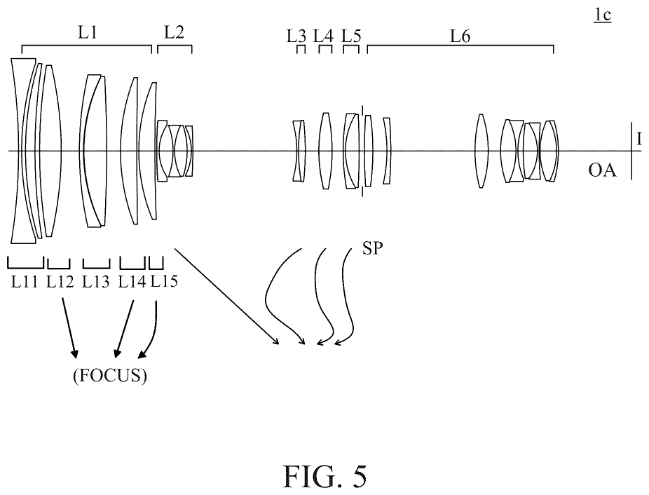

FIG. 5 illustrates a section of a zoom lens 1c according to Example 3 (numerical example 3) at a wide-angle end in an in-focus state at infinity.

The zoom lens 1c consists of, in order from the object side to the image side, a first lens unit L1 having positive refractive power, a second lens unit L2 having negative refractive power, a third lens unit L3 having negative refractive power, a fourth lens unit L4 having positive refractive power, a fifth lens unit L5 having positive refractive power, an aperture stop SP, and a sixth lens unit L6 having positive refractive power. The first lens unit L1 does not move during zooming, while the second lens unit L2, the third lens unit L3, the fourth lens unit L4, and the fifth lens unit L5, which constitute the intermediate group, move during zooming. The sixth lens unit L6 is the final lens unit for imaging, and does not move for zooming.

The first lens unit L1 includes, in order from the object side to the image side, a first sub-lens unit L11 having negative refractive power, a second sub-lens unit L12 having positive refractive power, a third sub-lens unit L13 having positive refractive power, a fourth sub-lens unit L14 having positive refractive power, and a fifth sub-lens unit L15 having positive refractive power. The second sub-lens unit L12, the fourth sub-lens unit L14, and the fifth sub-lens unit L15 are focus subgroups that move on different loci when focusing from infinity to a close distance, as illustrated by an arrow (FOCUS) in FIG. 5.

The second lens unit L2 corresponds to the object-side negative lens unit V, and moves to the image side as a variator during zooming from the wide-angle end to the telephoto end. The second lens unit L2 includes four lenses (two of which form a cemented lens), and the negative lens closest to the object is an aspheric lens. An optical unit such as an extender lens may be inserted into the sixth lens unit L6.

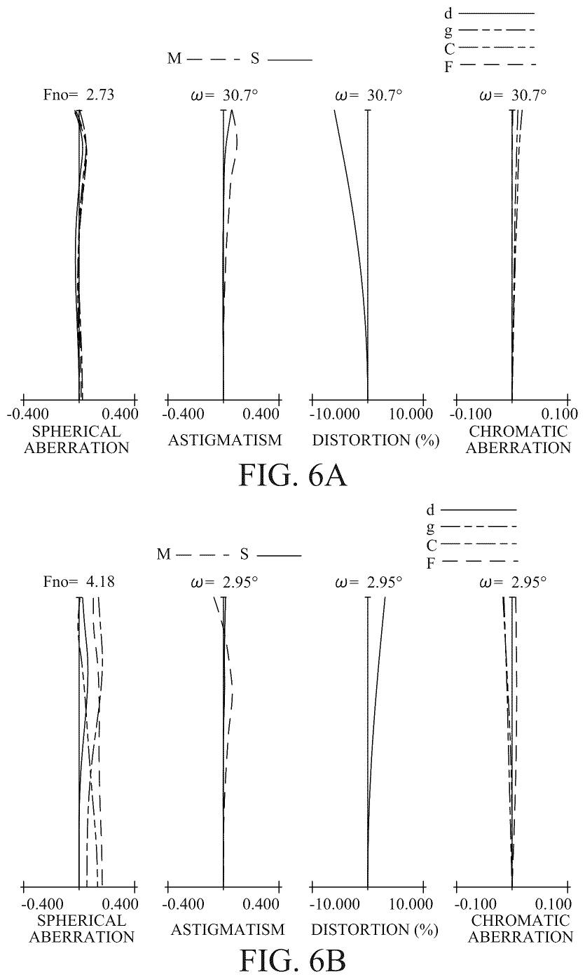

FIG. 6A illustrates a longitudinal aberration of the zoom lens 1c at a wide-angle end in an in-focus state at infinity, and FIG. 6B illustrates a longitudinal aberration of the zoom lens 1b at a telephoto end in an in-focus state at infinity.

### Example 4

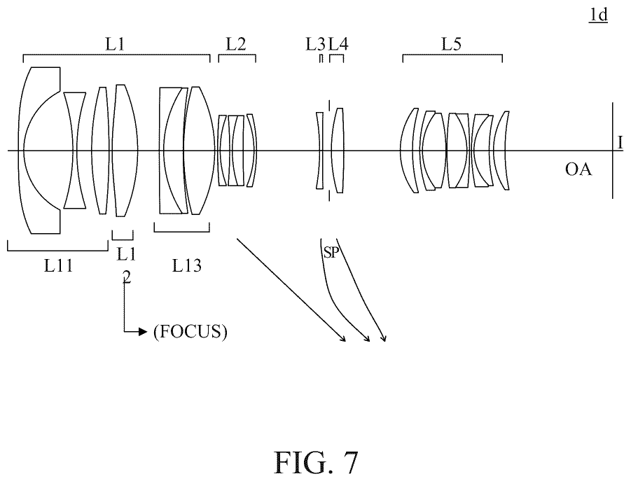

FIG. 7 illustrates a section of the zoom lens 1d according to Example 4 (numerical example 4) at a wide-angle end in an in-focus state at infinity.

The zoom lens 1d consists of, in order from the object side to the image side, a first lens unit L1 having positive refractive power, a second lens unit L2 having negative refractive power, a third lens unit L3 having negative refractive power, an aperture stop SP, a fourth lens unit L4 having positive refractive power, and a fifth lens unit L5 having positive refractive power. The first lens unit L1 does not move during zooming, while the second lens unit L2, the third lens unit L3, and the fourth lens unit L4 which constitute the intermediate group, move during zooming. The fifth lens unit L5 is the final lens unit for imaging, and does not move during zooming.

The first lens unit L1 includes, in order from the object side to the image side, a first sub-lens unit L11 having negative refractive power, a second sub-lens unit L12 having positive refractive power, and a third sub-lens unit L13 having positive refractive power. The second sub-lens unit L12 is a focus subgroup that moves from the object side to the image side during focusing from infinity to a close distance, as indicated by an arrow (FOCUS) in FIG. 7.

The second lens unit L2 corresponds to the object-side negative lens unit V, and moves to the image side as a variator during zooming from the wide-angle end to the telephoto end. The second lens unit L2 includes four lenses (two of which form a cemented lens), and the negative lens closest to the object is an aspheric lens. In this example, the second lens unit L2 corresponds to the object-side negative lens unit V. The fourth lens unit L4 moves integrally with the aperture stop SP during zooming. An optical unit such as an extender lens may be inserted into the fifth lens unit L5.

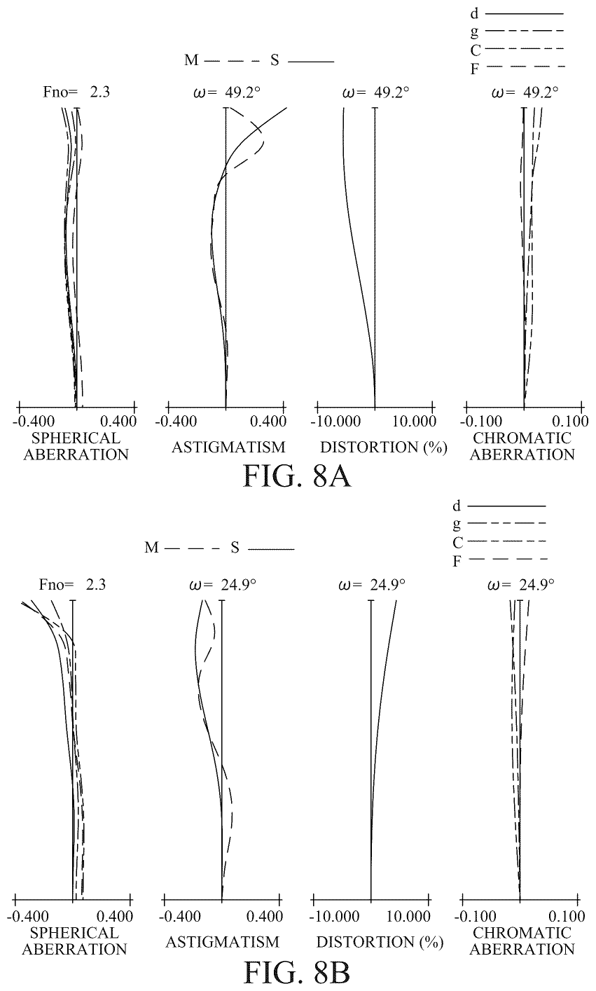

FIG. 8A illustrates a longitudinal aberration of the zoom lens 1d at a wide-angle end in an in-focus state at infinity and, and FIG. 8B illustrates a longitudinal aberration of the zoom lens 1d at a telephoto end in an in-focus state at infinity.

### Example 5

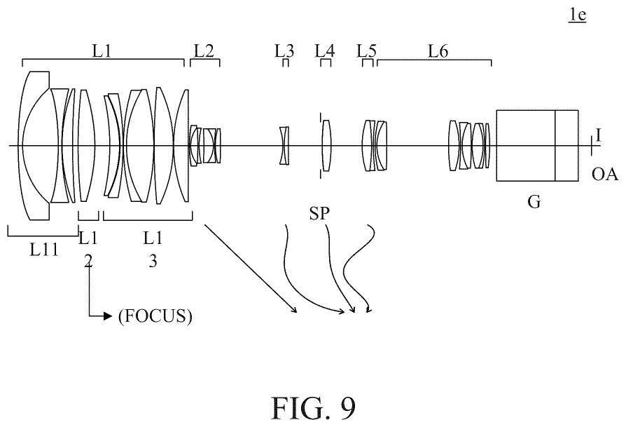

FIG. 9 illustrates a section of a zoom lens 1e according to Example 5 (numerical example 5) at a wide-angle end in an in-focus state at infinity.

The zoom lens 1e includes, in order from the object side to the image side, a first lens unit L1 having positive refractive power, a second lens unit L2 having negative refractive power, a third lens unit L3 having negative refractive power, an aperture stop SP, a fourth lens unit L4 having positive refractive power, a fifth lens unit L5 having positive refractive power, and a sixth lens unit having positive refractive power. G is an optical block such as a prism or an optical filter.

The first lens unit L1 does not move during zooming, and the second lens unit L2, the third lens unit L3, the fourth lens unit L4, and the fifth lens unit L5, which constitute the intermediate groups, do move during zooming. The sixth lens unit L6 is the final lens unit for imaging, and does not move during zooming.

The first lens unit L1 includes, in order from the object side to the image side, a first sub-lens unit L11 having negative refractive power, a second sub-lens unit L12 having positive refractive power, and a third sub-lens unit L13 having positive refractive power. The second sub-lens unit L12 is a focus subgroup that moves from the object side to the image side during focusing from infinity to a close distance, as indicated by an arrow (FOCUS) in FIG. 9.

The second lens unit L2 corresponds to the object-side negative lens unit V, and moves to the image side as a variator during zooming from the wide-angle end to the telephoto end. The second lens unit L2 includes five lenses (two of which form one cemented lens), and the negative lens closest to the object is an aspheric lens. The fourth lens unit L4 moves together with the aperture stop SP during zooming. An optical unit such as an extender lens may be inserted into the sixth lens unit L6.

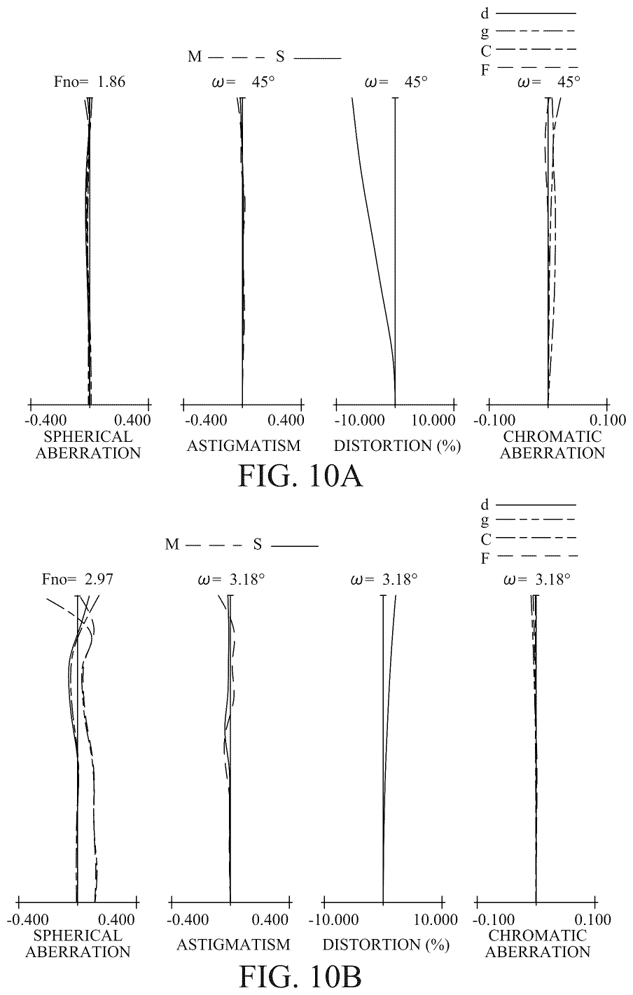

FIG. 10A illustrates a longitudinal aberration of the zoom lens 1e at a wide-angle end in an in-focus state at infinity, and FIG. 10B illustrates a longitudinal aberration of the zoom lens 1e at a telephoto end in an in-focus state at infinity.

### Example 6

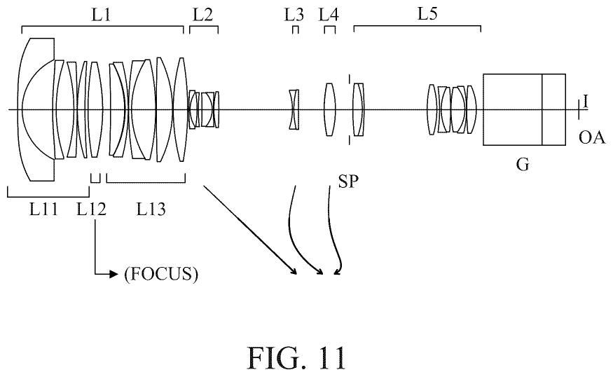

FIG. 11 illustrates a section of a zoom lens 1f according to Example 6 (numerical example 6) at a wide-angle end in an in-focus state at infinity.

The zoom lens 1f includes, in order from the object side to the image side, a first lens unit L1 having positive refractive power, a second lens unit L2 having negative refractive power, a third lens unit L3 having negative refractive power, a fourth lens unit L4 having positive refractive power, an aperture stop SP, and a fifth lens unit L5 having positive refractive power. G is an optical block such as a prism or an optical filter.

The first lens unit L1 does not move during zooming, and the second lens unit L2, the third lens unit L3, and the fourth lens unit L4, which constitute the intermediate group, move during zooming. The fifth lens unit L5 is the final lens unit for imaging and does not move during zooming.

The first lens unit L1 includes, in order from the object side to the image side, a first sub-lens unit L11 having negative refractive power, a second sub-lens unit L12 having positive refractive power, and a third sub-lens unit L13 having positive refractive power. The second sub-lens unit L12 is a focus subgroup that moves from the object side to the image side during focusing from infinity to a close distance, as indicated by an arrow (FOCUS) in FIG. 11.

The second lens unit L2 corresponds to the object-side negative lens unit V, and moves to the image side as a variator during zooming from the wide-angle end to the telephoto end. The second lens unit L2 includes five lenses (two of which form one cemented lens), and the negative lens closest to the object is an aspheric lens. An optical unit such as an extender lens may be inserted into the fifth lens unit L5.

Numerical examples 1 to 6 will be illustrated below. In each numerical example, a surface number i is the order of a surface counted from the object side, r represents a radius of curvature of an i-th surface (mm), and d represents a distance on the optical axis between i-th and (i+1)-th surfaces (mm). A portion where the distance d is (variable) indicates a distance that changes during zooming and accord with a focal length illustrated in a separate table.

nd is a refractive index (absolute refractive index at 1 atmosphere) for the d-line of the optical material between i-th and (i+1)-th surfaces. vd is an Abbe number based on the d-line of the optical material between i-th and (i+1)-th surfaces. θgF is a partial dispersion ratio for the g-line and F-line of the optical material between i-th and (i+1)-th surfaces.

In addition to a specification, such as a focal length and an F-number, of the zoom lens, each numerical example illustrates a half angle of view (°) of the zoom lens. BF represents a back focus, which is an air equivalent length from a (final) surface closest to the image plane of the zoom lens to the image surface. An overall lens length is a distance from a (foremost) surface closest to the object of a zoom lens to the final surface plus the back focus. WIDE, MIDDLE, and TELE represent a wide-angle end, an intermediate zoom position, and a telephoto end, respectively.

An asterisk “*” next to a surface number means that the surface has an aspheric shape. The aspheric shape is expressed by the following equation:

$$x = \frac{{H}^{2} / R}{1 + \sqrt{1 - ( 1 + k ) {( H / R )}^{2}}} + A 4 \cdot {H}^{4} + A 6 {H}^{6} + A 8 {H}^{8} + A 10 {H}^{10} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

where x is a displacement amount from a surface vertex in the optical axis direction, His a height from the optical axis in a direction perpendicular to the optical axis, a light traveling direction is positive, R is a paraxial radius of curvature, k is a conic constant, and A3 to A16 are aspheric coefficients.

In the conic constant and aspheric coefficients, “e-X” means “×10^{-X}.”

The lens unit data illustrates a focal length of each lens unit. Table 1 summarizes values of inequalities (1) to (9) for each numerical example. The zoom lens according to each numerical example satisfies all of inequalities (1) to (9).

### Numerical Example 1

UNIT: mm
SURFACE DATA

| Surface No. | r | d | nd | vd | θgF |
|---|---|---|---|---|---|
| 1* | ∞ | 2.80 | 1.80100 | 35.0 | 0.5864 |
| 2 | 45.306 | 26.83 | | | |
| 3 | −76.888 | 2.00 | 1.64000 | 60.1 | 0.5370 |
| 4 | 130.776 | 1.31 | | | |
| 5 | 139.162 | 8.49 | 1.95906 | 17.5 | 0.6598 |
| 6 | −402.098 | 1.19 | | | |
| 7 | 646.982 | 11.36 | 1.59522 | 67.7 | 0.5442 |
| 8* | −82.754 | 5.15 | | | |
| 9 | 514.992 | 9.73 | 1.43875 | 94.7 | 0.5340 |
| 10 | −98.376 | 2.00 | 1.84666 | 23.8 | 0.6205 |
| 11 | −275.863 | 0.20 | | | |
| 12 | 194.597 | 7.32 | 1.49700 | 81.5 | 0.5375 |
| 13 | −296.206 | 0.20 | | | |
| 14 | 155.285 | 2.00 | 1.80518 | 25.4 | 0.6161 |
| 15 | 58.335 | 17.85 | 1.43875 | 94.7 | 0.5340 |
| 16 | −162.863 | 0.20 | | | |
| 17 | 131.230 | 10.48 | 1.76385 | 48.5 | 0.5589 |
| 18 | −154.452 | (Variable) | | | |
| 19* | 117.501 | 1.24 | 2.05090 | 26.9 | 0.6054 |
| 20 | 23.330 | 7.71 | | | |
| 21 | −33.594 | 0.85 | 1.49700 | 81.5 | 0.5375 |
| 22 | 35.319 | 5.34 | 1.85478 | 24.8 | 0.6122 |
| 23 | −49.243 | 1.51 | | | |
| 24 | −28.530 | 1.00 | 1.88300 | 40.8 | 0.5667 |
| 25 | −55.566 | (Variable) | | | |
| 26 | −34.067 | 0.80 | 1.59522 | 67.7 | 0.5442 |
| 27 | 73.984 | 2.39 | 1.85896 | 22.7 | 0.6284 |
| 28 | 344.383 | (Variable) | | | |
| 29* | 73.879 | 5.01 | 1.89190 | 37.1 | 0.5780 |
| 30 | −161.379 | (Variable) | | | |
| 31 | 86.610 | 1.10 | 2.00069 | 25.5 | 0.6136 |
| 32 | 40.331 | 7.35 | 1.55200 | 70.7 | 0.5421 |
| 33 | −124.178 | (Variable) | | | |
| 34 (SP) | ∞ | 1.00 | | | |
| 35 | 126.863 | 5.96 | 1.48749 | 70.2 | 0.5300 |
| 36 | −61.210 | 0.25 | | | |
| 37 | −184.110 | 5.67 | 1.76182 | 26.5 | 0.6136 |
| 38 | −32.960 | 1.10 | 2.00100 | 29.1 | 0.5997 |
| 39 | 533.450 | 41.06 | | | |
| 40 | −677.771 | 5.71 | 1.48749 | 70.2 | 0.5300 |
| 41 | −37.548 | 2.04 | | | |
| 42 | 49.952 | 7.10 | 1.80810 | 22.8 | 0.6307 |
| 43 | −40.270 | 0.90 | 2.00100 | 29.1 | 0.5997 |
| 44 | 36.481 | 1.73 | | | |
| 45 | 32.405 | 11.06 | 1.43875 | 94.7 | 0.5340 |
| 46 | −23.422 | 1.00 | 1.88300 | 40.8 | 0.5667 |
| 47 | 191.906 | 0.50 | | | |
| 48 | 52.888 | 7.16 | 1.48749 | 70.2 | 0.5300 |
| 49 | −44.634 | 44.77 | | | |
| Image Plane | ∞ | | | | |

ASPHERIC DATA

| | | | |
|---|---|---|---|
| 1st Surface | | | |
| K = 0.00000e+00 | A4 = 5.17853e−07 | A6 = 5.27289e−10 | A8 = −6.93652e−13 |
| A10 = 4.72801e−16 | A12 = −1.88957e−19 | A14 = 4.12626e−23 | A16 = −3.82327e−27 |
| 8th Surface | | | |
| K = 0.00000e+00 | A4 = 5.70451e−07 | A6 = 8.31297e−11 | A8 = −8.23396e−14 |
| A10 = 1.96459e−16 | A12 = −2.97759e−19 | A14 = 2.00949e−22 | A16 = −5.03199e−26 |
| 19th Surface | | | |
| K = 0.00000e+00 | A4 = 3.75208e−06 | A6 = −2.79727e−09 | A8 = 1.59700e−11 |
| A10 = −7.27063e−14 | A12 = 1.95147e−16 | | |
| 29th Surface | | | |
| K = 0.00000e+00 | A4 = −1.64984e−06 | A6 = 5.45725e−10 | A8 = −3.16916e−13 |

VARIOUS DATA
ZOOM RATIO 8.22

| | WIDE | MIDDLE | TELE |
|---|---|---|---|
| Focal Length | 15.08 | 58.04 | 124.02 |
| Fno | 2.72 | 2.72 | 3.77 |
| Half Angle of View (°) | 44.46 | 14.30 | 6.81 |
| Image Height | 14.80 | 14.80 | 14.80 |
| Overall Lens Length | 340.03 | 340.03 | 340.03 |
| BF | 44.77 | 44.77 | 44.77 |
| d18 | 0.99 | 38.95 | 48.44 |
| d25 | 33.07 | 2.45 | 2.31 |
| d28 | 17.89 | 15.68 | 1.16 |
| d30 | 6.17 | 2.39 | 1.50 |
| d33 | 1.50 | 0.14 | 6.21 |

LENS UNIT DATA

| Lens Unit | Starting Surface | Focal Length |
|---|---|---|
| 1 | 1 | 41.26 |
| 2 | 19 | −26.27 |
| 3 | 26 | −60.84 |
| 4 | 29 | 57.40 |
| 5 | 31 | 203.83 |
| 6 | 34 | 119.33 |

### Numerical Example 2

UNIT: mm
SURFACE DATA

| Surface No. | r | d | nd | vd | θgF |
|---|---|---|---|---|---|
| 1* | 10000.000 | 2.58 | 1.80400 | 46.5 | 0.5577 |
| 2 | 32.590 | 14.26 | | | |
| 3 | 93.927 | 1.65 | 1.88300 | 40.8 | 0.5667 |
| 4 | 44.959 | 18.42 | | | |
| 5 | −43.953 | 1.65 | 1.77250 | 49.6 | 0.5520 |
| 6 | −71.542 | 5.77 | | | |
| 7 | 565.785 | 7.99 | 1.89286 | 20.4 | 0.6393 |
| 8 | −117.933 | 1.61 | | | |
| 9 | 115.176 | 9.95 | 1.49700 | 81.5 | 0.5375 |
| 10* | −159.676 | 11.65 | | | |
| 11 | −2566.642 | 9.34 | 1.43875 | 94.7 | 0.5340 |
| 12 | −64.155 | 2.00 | 2.00100 | 29.1 | 0.5997 |
| 13 | −74.025 | 0.20 | | | |
| 14 | 104.797 | 1.84 | 1.96300 | 24.1 | 0.6212 |
| 15 | 47.782 | 11.71 | 1.49700 | 81.5 | 0.5375 |
| 16 | −121.878 | 0.50 | | | |
| 17 | 148.537 | 8.00 | 1.49700 | 81.5 | 0.5375 |
| 18 | −140.367 | (Variable) | | | |
| 19* | 107.996 | 1.20 | 2.05090 | 26.9 | 0.6054 |
| 20 | 28.944 | 5.00 | | | |
| 21 | −82.229 | 0.83 | 1.49700 | 81.5 | 0.5375 |
| 22 | 28.282 | 4.39 | 1.85478 | 24.8 | 0.6122 |
| 23 | −296.990 | 0.83 | 1.76385 | 48.5 | 0.5589 |
| 24 | 103.912 | (Variable) | | | |
| 25 | −46.645 | 0.83 | 1.88300 | 40.8 | 0.5667 |
| 26 | 73.071 | 2.06 | 1.92286 | 18.9 | 0.6495 |
| 27 | −2265.947 | (Variable) | | | |
| 28 (SP) | ∞ | 1.00 | | | |
| 29* | 36.924 | 3.81 | 1.69680 | 55.5 | 0.5434 |
| 30 | 274.187 | (Variable) | | | |
| 31 | 92.171 | 1.11 | 2.00069 | 25.5 | 0.6136 |
| 32 | 35.401 | 5.63 | 1.51823 | 58.9 | 0.5457 |
| 33 | −87.881 | 35.00 | | | |
| 34 | 87.968 | 4.90 | 1.49700 | 81.5 | 0.5375 |
| 35 | −46.509 | 0.37 | | | |
| 36 | 416.555 | 3.77 | 1.92286 | 18.9 | 0.6495 |
| 37 | −49.455 | 0.83 | 1.91650 | 31.6 | 0.5911 |
| 38 | 262.820 | 10.00 | | | |
| 39 | 51.195 | 6.72 | 1.43875 | 94.7 | 0.5340 |
| 40 | −26.203 | 0.92 | 2.00100 | 29.1 | 0.5997 |
| 41 | 82.576 | 0.65 | | | |
| 42 | 38.677 | 6.56 | 1.48749 | 70.2 | 0.5300 |
| 43 | −70.233 | 38.98 | | | |
| Image Plane | ∞ | | | | |

ASPHERIC DATA

| | | | |
|---|---|---|---|
| 1st Surface | | | |
| K = 0.00000e+00 | A4 = 4.18291e−06 | A6 = −2.97629e−09 | A8 = 2.26460e−12 |
| A10 = −1.23261e−15 | A12 = 3.82334e−19 | A14 = −3.82317e−23 | A16 = −4.93139e−27 |
| 10th Surface | | | |
| K = 0.00000e+00 | A4 = 1.39531e−06 | A6 = −2.83059e−10 | A8 = 1.22795e−13 |
| A10 = −1.02418e−16 | A12 = 3.09917e−20 | | |
| 19th Surface | | | |
| K = 0.00000e+00 | A4 = −7.21477e−07 | A6 = −2.32086e−09 | A8 = 1.93226e−11 |
| A10 = −1.16522e−13 | A12 = 2.44693e−16 | | |
| 29th Surface | | | |
| K = 0.00000e+00 | A4 = −5.27893e−06 | A6 = 9.60956e−10 | A8 = −3.16459e−12 |

VARIOUS DATA
ZOOM RATIO 4.00

| | WIDE | MIDDLE | TELE |
|---|---|---|---|
| Focal Length | 12.50 | 27.91 | 49.99 |
| Fno | 2.69 | 2.69 | 3.09 |
| Half Angle of View(°) | 49.82 | 27.94 | 16.49 |
| Image Height | 14.80 | 14.80 | 14.80 |
| Overall Lens Length | 291.28 | 291.28 | 291.28 |
| BF | 38.98 | 38.98 | 38.98 |
| d18 | 0.50 | 26.13 | 37.11 |
| d24 | 16.64 | 3.63 | 6.85 |
| d27 | 19.96 | 13.83 | 1.29 |
| d30 | 9.66 | 3.18 | 1.51 |

LENS UNIT DATA

| Lens Unit | Starting Surface | Focal Length |
|---|---|---|
| 1 | 1 | 27.64 |
| 2 | 19 | −36.85 |
| 3 | 25 | −55.68 |
| 4 | 28 | 60.84 |
| 5 | 31 | 70.49 |

### Numerical Example 3

UNIT: mm
SURFACE DATA

| Surface No. | r | d | nd | vd | θgF |
|---|---|---|---|---|---|
| 1 | −298.726 | 1.60 | 1.89190 | 37.1 | 0.5780 |
| 2 | 147.923 | 2.01 | | | |
| 3 | 158.765 | 4.92 | 1.98612 | 16.5 | 0.6657 |
| 4 | 287.958 | 2.39 | | | |
| 5 | 280.011 | 11.22 | 1.49700 | 81.5 | 0.5375 |
| 6* | −185.843 | 9.43 | | | |
| 7 | 179.212 | 2.10 | 1.85478 | 24.8 | 0.6122 |
| 8 | 87.572 | 0.27 | | | |
| 9 | 89.176 | 11.76 | 1.53775 | 74.7 | 0.5392 |
| 10 | −747.731 | 7.19 | | | |
| 11 | 106.075 | 8.53 | 1.53775 | 74.7 | 0.5392 |
| 12 | 2546.824 | 1.00 | | | |
| 13 | 92.547 | 8.34 | 1.61800 | 63.3 | 0.5426 |
| 14 | 866.235 | (Variable) | | | |
| 15* | 412.405 | 1.20 | 2.05090 | 26.9 | 0.6054 |
| 16 | 24.508 | 7.25 | | | |
| 17 | −38.635 | 0.80 | 1.52841 | 76.5 | 0.5396 |
| 18 | 30.110 | 6.51 | 1.85478 | 24.8 | 0.6122 |
| 19 | −42.813 | 2.20 | | | |
| 20 | −27.265 | 0.75 | 1.76385 | 48.5 | 0.5589 |
| 21 | −239.767 | (Variable) | | | |
| 22 | −55.914 | 0.90 | 1.88300 | 40.8 | 0.5667 |
| 23 | 94.395 | 3.48 | 1.85478 | 24.8 | 0.6122 |
| 24 | −149.521 | (Variable) | | | |
| 25* | 74.801 | 6.89 | 1.76385 | 48.5 | 0.5589 |
| 26 | −98.208 | (Variable) | | | |
| 27 | 107.857 | 1.20 | 1.85478 | 24.8 | 0.6122 |
| 28 | 37.690 | 7.11 | 1.59522 | 67.7 | 0.5442 |
| 29 | −361.701 | (Variable) | | | |
| 30 (SP) | ∞ | 1.00 | | | |
| 31 | 275.057 | 4.41 | 1.53775 | 74.7 | 0.5392 |
| 32 | −132.095 | 7.31 | | | |
| 33 | −77.008 | 2.00 | 1.88300 | 40.8 | 0.5667 |
| 34 | −216.738 | 43.69 | | | |
| 35 | 76.510 | 6.85 | 1.55200 | 70.7 | 0.5421 |
| 36 | −62.564 | 6.44 | | | |
| 37 | 48.673 | 7.98 | 1.89286 | 20.4 | 0.6393 |
| 38 | −37.719 | 1.00 | 2.05090 | 26.9 | 0.6054 |
| 39 | 37.396 | 2.76 | | | |
| 40 | 97.544 | 7.35 | 1.48749 | 70.2 | 0.5300 |
| 41 | −25.465 | 0.90 | 1.89190 | 37.1 | 0.5780 |
| 42 | 174.494 | 0.51 | | | |
| 43 | 38.737 | 8.55 | 1.48749 | 70.2 | 0.5300 |
| 44 | −35.456 | 0.95 | 2.00069 | 25.5 | 0.6136 |
| 45 | −55.422 | 37.99 | | | |
| Image Plane | ∞ | | | | |

ASPHERIC DATA

| | | | |
|---|---|---|---|
| 6th Surface | | | |
| K = −5.68862e−01 | A4 = 5.47754e−08 | A6 = −1.24236e−12 | A8 = −1.07816e−15 |
| 15th Surface | | | |
| K = 1.92279e+00 | A4 = 3.81337e−06 | A6 = −2.75045e−09 | A8 = 1.48101e−11 |
| A10 = −4.33253e−14 | A12 = 8.22883e−17 | | |
| 25th Surface | | | |
| K = 2.00015e+00 | A4 = −2.15756e−06 | A6 = 1.15981e−10 | A8 = −1.57896e−13 |

VARIOUS DATA
ZOOM RATIO 11.51

| | WIDE | MIDDLE | TELE |
|---|---|---|---|
| Focal Length | 24.92 | 89.42 | 286.96 |
| Fno | 2.73 | 2.73 | 4.18 |
| Half Angle of View(°) | 30.70 | 9.40 | 2.95 |
| Image Height | 14.80 | 14.80 | 14.80 |
| Overall Lens Length | 318.17 | 318.17 | 318.17 |
| BF | 37.99 | 37.99 | 37.99 |
| d14 | 1.00 | 38.59 | 54.70 |
| d21 | 53.98 | 2.00 | 2.01 |
| d24 | 7.03 | 21.18 | 1.16 |
| d26 | 5.73 | 5.27 | 1.50 |
| d29 | 1.72 | 2.42 | 10.09 |

LENS UNIT DATA

| Lens Unit | Starting Surface | Focal Length |
|---|---|---|
| 1 | 1 | 83.13 |
| 2 | 15 | −19.43 |
| 3 | 22 | −98.42 |
| 4 | 25 | 56.56 |
| 5 | 27 | 369.96 |
| 6 | 30 | 133.92 |

### Numerical Example 4

UNIT: mm
SURFACE DATA

| Surface No. | r | d | nd | vd | θgF |
|---|---|---|---|---|---|
| 1* | 1000.000 | 2.60 | 1.78800 | 47.4 | 0.5559 |
| 2 | 32.299 | 23.71 | | | |
| 3 | −90.802 | 1.90 | 1.76385 | 48.5 | 0.5589 |
| 4 | 90.802 | 7.17 | | | |
| 5 | 120.800 | 8.39 | 1.84666 | 23.8 | 0.6205 |
| 6 | −305.584 | 1.50 | | | |
| 7* | 133.699 | 12.35 | 1.59522 | 67.7 | 0.5442 |
| 8 | −82.940 | 10.44 | | | |
| 9 | 1725.489 | 2.10 | 1.80518 | 25.4 | 0.6161 |
| 10 | 55.871 | 9.41 | 1.43875 | 94.7 | 0.5340 |
| 11 | 203.972 | 0.20 | | | |
| 12 | 118.020 | 15.03 | 1.72916 | 54.7 | 0.5444 |
| 13 | −67.209 | (Variable) | | | |
| 14* | 205.547 | 1.25 | 2.05090 | 26.9 | 0.6054 |
| 15 | 48.364 | 4.59 | | | |
| 16 | −203.099 | 1.25 | 1.59522 | 67.7 | 0.5442 |
| 17 | 56.505 | 5.21 | 1.95906 | 17.5 | 0.6598 |
| 18 | 387.830 | 5.28 | | | |
| 19 | −43.707 | 1.25 | 1.88300 | 40.8 | 0.5667 |
| 20 | −72.099 | (Variable) | | | |
| 21 | −103.496 | 1.40 | 1.43875 | 94.7 | 0.5340 |
| 22 | 1152.733 | (Variable) | | | |
| 23 (SP) | ∞ | 1.00 | | | |
| 24 | 74.231 | 6.01 | 1.80610 | 40.9 | 0.5713 |
| 25* | −252.102 | (Variable) | | | |
| 26 | 34.472 | 5.90 | 1.51633 | 64.1 | 0.5353 |
| 27 | 72.860 | 3.50 | | | |
| 28 | 59.699 | 1.30 | 2.00100 | 29.1 | 0.5997 |
| 29 | 29.646 | 11.36 | 1.43875 | 94.7 | 0.5340 |
| 30 | −70.883 | 0.45 | | | |
| 31 | 134.895 | 9.65 | 1.80810 | 22.8 | 0.6307 |
| 32 | −31.578 | 1.30 | 2.00100 | 29.1 | 0.5997 |
| 33 | −190.743 | 0.91 | | | |
| 34 | 84.793 | 1.20 | 2.00100 | 29.1 | 0.5997 |
| 35 | 23.466 | 7.31 | 1.49700 | 81.5 | 0.5375 |
| 36 | 71.932 | 2.10 | | | |
| 37 | 35.085 | 5.57 | 1.49700 | 81.5 | 0.5375 |
| 38 | 92.149 | 51.99 | | | |
| Surface Data | ∞ | | | | |

ASPHERIC DATA

| | | | |
|---|---|---|---|
| 1st Surface | | | |
| K = 0.00000e+00 | A4 = 3.58870e−06 | A6 = −2.14135e−09 | A8 = 1.47525e−12 |
| A10 = −8.12339e−16 | A12 = 3.46755e−19 | A14 = −1.00783e−22 | A16 = 1.44431e−26 |
| 7th Surface | | | |
| K = 0.00000e+00 | A4 = −2.10391e−06 | A6 = 7.90945e−10 | A8 = −1.74703e−12 |
| A10 = 3.45388e−15 | A12 = −4.08574e−18 | A14 = 2.61795e−21 | A16 = −6.95832e−25 |
| 14th Surface | | | |
| K = −7.36061e−01 | A4 = 7.22343e−08 | A6 = −1.52191e−10 | A8 = 1.09496e−12 |
| A10 = −2.08267e−15 | A12 = 1.14680e−18 | | |
| 25th Surface | | | |
| K = 0.00000e+00 | A4 = 1.47861e−06 | A6 = 2.63873e−10 | A8 = −3.53362e−13 |

VARIOUS DATA
ZOOM RATIO 2.50

| | WIDE | MIDDLE | TELE |
|---|---|---|---|
| Focal Length | 20.00 | 35.00 | 49.99 |
| Fno | 2.30 | 2.30 | 2.30 |
| Half Angle of View(°) | 49.24 | 33.54 | 24.89 |
| Image Height | 23.20 | 23.20 | 23.20 |
| Overall Lens Length | 286.93 | 286.93 | 286.93 |
| BF | 51.99 | 51.99 | 51.99 |
| d13 | 1.40 | 36.36 | 53.55 |
| d20 | 30.44 | 3.04 | 1.55 |
| d22 | 3.26 | 10.42 | 3.26 |
| d25 | 27.26 | 12.55 | 3.99 |

LENS UNIT DATA

| Lens Unit | Starting Surface | Focal Length |
|---|---|---|
| 1 | 1 | 51.49 |
| 2 | 14 | −40.47 |
| 3 | 21 | −216.38 |
| 4 | 23 | 71.73 |
| 5 | 26 | 91.86 |

### Numerical Example 5

UNIT: mm
SURFACE DATA

| Surface No. | r | d | nd | vd | θgF |
|---|---|---|---|---|---|
| 1* | 208.829 | 2.50 | 1.83481 | 42.7 | 0.5648 |
| 2 | 42.979 | 20.22 | | | |
| 3* | −146.676 | 2.00 | 1.89190 | 37.1 | 0.5780 |
| 4 | 133.898 | 0.15 | | | |
| 5 | 89.888 | 5.94 | 1.95906 | 17.5 | 0.6598 |
| 6 | 396.326 | 3.12 | | | |
| 7 | 285.020 | 9.53 | 1.59522 | 67.7 | 0.5442 |
| 8* | −90.951 | 8.44 | | | |
| 9 | −124.552 | 5.54 | 1.43387 | 95.1 | 0.5373 |
| 10 | −63.104 | 0.30 | | | |
| 11 | −62.877 | 1.70 | 1.80000 | 29.8 | 0.6017 |
| 12 | −152.423 | 0.18 | | | |
| 13 | 114.339 | 1.70 | 2.00100 | 29.1 | 0.5997 |
| 14 | 61.814 | 15.48 | 1.49700 | 81.5 | 0.5375 |
| 15 | −121.372 | 0.20 | | | |
| 16 | 356.300 | 10.87 | 1.43387 | 95.1 | 0.5373 |
| 17 | −76.581 | 0.20 | | | |
| 18 | 80.452 | 8.31 | 1.76385 | 48.5 | 0.5589 |
| 19 | −12653.070 | (Variable) | | | |
| 20* | 72.226 | 0.70 | 2.05090 | 26.9 | 0.6054 |
| 21 | 16.800 | 4.06 | | | |
| 22 | −155.568 | 0.70 | 1.43875 | 94.7 | 0.5340 |
| 23 | 42.302 | 2.72 | | | |
| 24 | −146.175 | 5.36 | 1.85478 | 24.8 | 0.6122 |
| 25 | −15.612 | 0.70 | 1.88300 | 40.8 | 0.5667 |
| 26 | 74.487 | 0.43 | | | |
| 27 | 36.672 | 2.88 | 1.73800 | 32.3 | 0.5900 |
| 28 | −220.003 | (Variable) | | | |
| 29 | −30.840 | 0.80 | 1.72916 | 54.7 | 0.5444 |
| 30 | 49.687 | 2.38 | 1.84666 | 23.8 | 0.6205 |
| 31 | 1984.632 | (Variable) | | | |
| 32 (SP) | ∞ | 1.00 | | | |
| 33* | 118.953 | 5.04 | 1.89190 | 37.1 | 0.5780 |
| 34 | −75.584 | (Variable) | | | |
| 35 | 46.778 | 5.33 | 1.51742 | 52.4 | 0.5564 |
| 36 | −98.699 | 1.00 | 1.83481 | 42.7 | 0.5648 |
| 37 | 105.890 | (Variable) | | | |
| 38 | 56.779 | 1.00 | 1.95375 | 32.3 | 0.5905 |
| 39 | 24.833 | 5.63 | 1.51633 | 64.1 | 0.5353 |
| 40 | −431.483 | 35.00 | | | |
| 41 | 97.774 | 6.00 | 1.63980 | 34.5 | 0.5922 |
| 42 | −44.117 | 0.80 | | | |
| 43 | −140.597 | 0.90 | 1.88300 | 40.8 | 0.5667 |
| 44 | 27.791 | 5.14 | 1.55200 | 70.7 | 0.5421 |
| 45 | −178.218 | 0.50 | | | |
| 46 | 43.965 | 6.20 | 1.43875 | 94.7 | 0.5340 |
| 47 | −33.355 | 0.90 | 2.00100 | 29.1 | 0.5997 |
| 48 | −64.288 | 0.50 | | | |
| 49 | 301.737 | 2.31 | 1.48749 | 70.2 | 0.5300 |
| 50 | −95.058 | 4.00 | | | |
| 51 | ∞ | 33.00 | 1.60859 | 46.4 | 0.5664 |
| 52 | ∞ | 13.20 | 1.51680 | 64.2 | 0.5347 |
| 53 | ∞ | 7.45 | | | |
| Image Plane | ∞ | | | | |

ASPHERIC DATA

| | | | |
|---|---|---|---|
| 1st Surface | | | |
| K = 0.00000e+00 | A4 = −7.47662e−06 | A6 = −1.47215e−07 | A8 = −2.46563e−10 |
| A10 = 4.11514e−13 | A12 = 1.22984e−16 | A14 = −1.08151e−19 | A16 = −5.20408e−24 |
| A3 = 2.09871e−05 | A5 = 1.42449e−06 | A7 = 8.72980e−09 | A9 = −2.02602e−12 |
| A11 = −1.32062e−14 | A13 = 3.20728e−18 | A15 = 1.23717e−21 | |
| 3rd Surface | | | |
| K = 0.00000e+00 | A4 = 1.01909e−05 | A6 = 2.91856e−07 | A8 = 2.33150e−09 |
| A10 = 6.11514e−12 | A12 = 2.38406e−15 | A14 = −1.91675e−18 | A16 = −2.08863e−22 |
| A3 = −2.52129e−05 | A5 = −2.14476e−06 | A7 = −2.95677e−08 | A9 = −1.40308e−10 |
| A11 = −1.75105e−13 | A13 = 2.93400e−17 | A15 = 3.29607e−20 | |
| 8th Surface | | | |
| K = 0.00000e+00 | A4 = 3.94298e−06 | A6 = −7.42330e−08 | A8 = −1.93707e−09 |
| A10 = −5.79331e−12 | A12 = −3.06732e−15 | A14 = −6.44985e−19 | A16 = −8.11343e−23 |
| A3 = −1.14993e−05 | A5 = −1.55382e−07 | A7 = 1.74480e−08 | A9 = 1.31655e−10 |
| A11 = 1.65574e−13 | A13 = 4.17505e−17 | A15 = 1.03987e−20 | |
| 20th Surface | | | |
| K = 1.55546e+00 | A4 = 2.78255e−07 | A6 = −4.73484e−10 | A8 = −4.37626e−12 |
| 33rd Surface | | | |
| K = −3.93401e+01 | A4 = 1.76086e−06 | A6 = −2.89485e−09 | A8 = 2.28335e−12 |

VARIOUS DATA
ZOOM RATIO 18.02

| | WIDE | MIDDLE | TELE |
|---|---|---|---|
| Focal Length | 5.50 | 21.02 | 99.12 |
| Fno | 1.86 | 1.86 | 2.97 |
| Half Angle of View(°) | 45.00 | 14.67 | 3.18 |
| Image Height | 5.50 | 5.50 | 5.50 |
| Overall Lens Length | 324.65 | 324.65 | 324.65 |
| BF | 7.45 | 7.45 | 7.45 |
| d19 | 0.65 | 36.44 | 52.33 |
| d28 | 35.32 | 3.10 | 16.62 |
| d31 | 18.13 | 21.19 | 1.24 |
| d34 | 17.56 | 1.00 | 1.00 |
| d37 | 1.00 | 10.92 | 1.45 |

LENS UNIT DATA

| Lens Unit | Starting Surface | Focal Length |
|---|---|---|
| 1 | 1 | 40.24 |
| 2 | 20 | −18.35 |
| 3 | 29 | −46.09 |
| 4 | 32 | 52.46 |
| 5 | 35 | 2340.64 |
| 6 | 38 | 49.70 |

### Numerical Example 6

UNIT: mm
SURFACE DATA

| Surface No. | r | d | nd | vd | θgF |
|---|---|---|---|---|---|
| 1* | 1658.310 | 2.50 | 1.83481 | 42.7 | 0.5648 |
| 2 | 31.052 | 17.12 | | | |
| 3* | 165.877 | 2.00 | 1.83481 | 42.7 | 0.5648 |
| 4 | 86.855 | 9.99 | | | |
| 5 | −94.683 | 1.80 | 1.83481 | 42.7 | 0.5648 |
| 6 | −532.838 | 0.15 | | | |
| 7 | 94.232 | 4.27 | 1.92286 | 18.9 | 0.6495 |
| 8 | 357.216 | 1.71 | | | |
| 9 | 166.608 | 8.24 | 1.60300 | 65.4 | 0.5401 |
| 10* | −97.414 | 4.41 | | | |
| 11 | −603.969 | 7.95 | 1.43387 | 95.1 | 0.5373 |
| 12 | −55.416 | 0.33 | | | |
| 13 | −53.264 | 1.70 | 1.80000 | 29.8 | 0.6017 |
| 14 | −109.667 | 0.18 | | | |
| 15 | 168.829 | 1.70 | 1.91650 | 31.6 | 0.5911 |
| 16 | 53.722 | 13.56 | 1.43875 | 94.7 | 0.5340 |
| 17 | −120.939 | 0.40 | | | |
| 18 | 978.223 | 9.10 | 1.43387 | 95.1 | 0.5373 |
| 19 | −66.338 | 0.40 | | | |
| 20 | 111.808 | 8.12 | 1.76385 | 48.5 | 0.5589 |
| 21 | −168.562 | (Variable) | | | |
| 22* | 135.706 | 0.70 | 2.05090 | 26.9 | 0.6054 |
| 23 | 17.909 | 3.93 | | | |
| 24 | −62.560 | 0.70 | 1.43875 | 94.7 | 0.5340 |
| 25 | 81.625 | 2.11 | | | |
| 26 | −164.446 | 5.71 | 1.85478 | 24.8 | 0.6122 |
| 27 | −14.283 | 0.70 | 1.88300 | 40.8 | 0.5667 |
| 28 | 157.961 | 0.21 | | | |
| 29 | 41.883 | 2.86 | 1.73800 | 32.3 | 0.5900 |
| 30 | −191.791 | (Variable) | | | |
| 31 | −32.514 | 0.80 | 1.72916 | 54.7 | 0.5444 |
| 32 | 45.779 | 2.59 | 1.84666 | 23.8 | 0.6205 |
| 33 | 2489.967 | (Variable) | | | |
| 34* | 65.079 | 6.37 | 1.58913 | 61.1 | 0.5407 |
| 35 | −53.660 | (Variable) | | | |
| 36 (SP) | ∞ | 1.95 | | | |
| 37 | 130.028 | 5.31 | 1.51742 | 52.4 | 0.5564 |
| 38 | −45.807 | 1.00 | 1.83481 | 42.7 | 0.5648 |
| 39 | −171.417 | 35.50 | | | |
| 40 | 62.385 | 5.48 | 1.63980 | 34.5 | 0.5922 |
| 41 | −50.700 | 1.53 | | | |
| 42 | −91.839 | 0.90 | 1.88300 | 40.8 | 0.5667 |
| 43 | 27.881 | 5.28 | 1.48749 | 70.2 | 0.5300 |
| 44 | −140.321 | 0.20 | | | |
| 45 | 61.712 | 7.86 | 1.43875 | 94.7 | 0.5340 |
| 46 | −20.931 | 0.90 | 2.00100 | 29.1 | 0.5997 |
| 47 | −54.391 | 0.13 | | | |
| 48 | 143.444 | 5.38 | 1.48749 | 70.2 | 0.5300 |
| 49 | −31.599 | 4.00 | | | |
| 50 | ∞ | 33.00 | 1.60859 | 46.4 | 0.5664 |
| 51 | ∞ | 13.20 | 1.51680 | 64.2 | 0.5347 |
| 52 | ∞ | 7.45 | | | |
| Image Plane | ∞ | | | | |

ASPHERIC DATA

| | | | |
|---|---|---|---|
| 1st Surface | | | |
| K = 0.00000e+00 | A4 = 4.07369e−06 | A6 = 1.07123e−08 | A8 = 7.80444e−12 |
| A10 = 9.49529e−14 | A12 = 1.11177e−16 | A14 = 1.85178e−20 | A16 = −6.42205e−26 |
| A3 = 1.27705e−05 | A5 = −1.68113e−07 | A7 = −3.07821e−10 | A9 = −1.17404e−12 |
| A11 = −4.11434e−15 | A13 = −1.90018e−18 | A15 = −7.33161e−23 | |
| 3rd Surface | | | |
| K = 0.00000e+00 | A4 = −2.28149e−06 | A6 = −7.50517e−08 | A8 = −7.10699e−10 |
| A10 = −3.23653e−13 | A12 = 1.59720e−15 | A14 = −6.51703e−19 | A16 = −2.02837e−22 |
| A3 = −1.08050e−05 | A5 = 4.35381e−07 | A7 = 9.13498e−09 | A9 = 3.03383e−11 |
| A11 = −3.27445e−14 | A13 = −1.78369e−17 | A15 = 2.23156e−20 | |
| 10th Surface | | | |
| K = 0.00000e+00 | A4 = 1.14792e−06 | A6 = 1.37632e−08 | A8 = 2.71470e−10 |
| A10 = 2.08439e−13 | A12 = −7.68942e−16 | A14 = 1.05267e−18 | A16 = 2.18868e−22 |
| A3 = −3.26263e−06 | A5 = −2.00722e−08 | A7 = −2.66909e−09 | A9 = −1.44185e−11 |
| A11 = 1.68145e−14 | A13 = −4.82496e−18 | A15 = −2.63977e−20 | |
| 22nd Surface | | | |
| K = 3.26077e+01 | A4 = 3.46197e−06 | A6 = 4.66573e−08 | A8 = −2.68025e−10 |
| A10 = 2.62133e−12 | | | |
| A3 = −2.92893e−06 | A5 = −7.62030e−07 | A7 = 3.83578e−09 | A9 = −3.83807e−11 |
| 34th Surface | | | |
| K = −1.23593e+01 | A4 = 1.51830e−06 | A6 = −4.16722e−09 | A8 = 2.26731e−12 |

VARIOUS DATA
ZOOM RATIO 13.61

| | WIDE | MIDDLE | TELE |
|---|---|---|---|
| Focal Length | 4.43 | 15.50 | 60.26 |
| Fno | 1.86 | 1.86 | 2.77 |
| Half Angle of View(°) | 51.16 | 19.54 | 5.22 |
| Image Height | 5.50 | 5.50 | 5.50 |
| Overall Lens Length | 315.65 | 315.65 | 315.65 |
| BF | 7.45 | 7.45 | 7.45 |
| d21 | 0.65 | 35.73 | 52.42 |
| d30 | 41.36 | 5.66 | 4.62 |
| d33 | 14.46 | 17.85 | 2.09 |
| d35 | 7.81 | 5.04 | 5.15 |

LENS UNIT DATA

| Lens Unit | Starting Surface | Focal Length |
|---|---|---|
| 1 | 1 | 29.67 |
| 2 | 22 | −20.17 |
| 3 | 31 | −49.54 |
| 4 | 34 | 50.93 |
| 5 | 36 | 52.86 |

| | | Numerical Example | | | | | |
|---|---|---|---|---|---|---|---|
| | Inequality | 1 | 2 | 3 | 4 | 5 | 6 |
| (1) | nn | 2.05 | 2.05 | 2.05 | 2.05 | 2.05 | 2.05 |
| (2) | vn | 26.9 | 26.9 | 26.9 | 26.9 | 26.9 | 26.9 |
| (3) | fl/fw | 2.7 | 2.2 | 3.3 | 2.6 | 7.3 | 6.7 |
| (4) | fn/fV | 1.1 | 1.0 | 1.3 | 1.5 | 1.1 | 1.0 |
| (5) | θn + 0.00162 × vn | 0.65 | 0.65 | 0.65 | 0.65 | 0.65 | 0.65 |
| (6) | v | 82 | 82 | 76 | 68 | 95 | 95 |
| (7) | (θpₐᵥₑ − θnₐᵥₑ)/ | −0.0017 | −0.0016 | −0.0017 | −0.0032 | −0.0013 | −0.0013 |
| | (vpₐᵥₑ − vnₐᵥₑ) | | | | | | |
| (8) | fV/fw | −1.7 | −2.9 | −0.8 | −2.0 | −3.3 | −4.6 |
| (9) | fw/IS | 0.5 | 0.4 | 0.8 | 0.5 | 0.5 | 0.4 |
| | fl | 41.3 | 27.6 | 83.0 | 51.5 | 40.2 | 29.7 |
| | fw | 15.1 | 12.5 | 24.9 | 20.0 | 5.5 | 4.4 |
| | fn | −27.9 | −37.9 | −24.6 | −60.4 | −21.0 | −19.7 |
| | fV | −26.3 | −36.9 | −19.4 | −40.5 | −18.3 | −20.2 |
| | θpₐᵥₑ | 0.612 | 0.612 | 0.612 | 0.660 | 0.601 | 0.601 |
| | θnₐᵥₑ | 0.570 | 0.567 | 0.568 | 0.572 | 0.569 | 0.569 |
| | vpₐᵥₑ | 24.80 | 24.80 | 24.80 | 17.47 | 28.57 | 28.57 |
| | vnₐᵥₑ | 49.75 | 52.32 | 50.63 | 45.15 | 54.12 | 54.12 |
| | IS | 29.6 | 29.6 | 29.6 | 43.3 | 11.0 | 11.0 |

### Image Pickup Apparatus

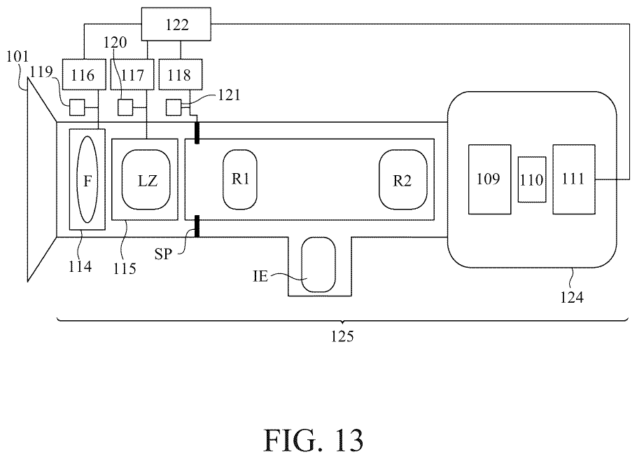

FIG. 13 illustrates an image pickup apparatus using the zoom lens according to any one of the above examples as an imaging optical system. In FIG. 13, reference numeral 101 denotes one of the zoom lenses according to Examples 1 to 6. Reference numeral 124 denotes a camera body. An image pickup apparatus 125 is configured by detachably attaching the zoom lens 101 to the camera body 124. However, the image pickup apparatus may be one in which the zoom lens 101 is integrated with the camera body 124.

The zoom lens 101 includes a first lens unit F, a zoom unit LZ, and an imaging lens unit R. The first lens unit F includes a focus subgroup that moves during focusing.

The zoom unit LZ includes at least three or more lens units that move during zooming. An aperture stop SP, a lens unit R1, and a lens unit R2 are disposed on the image side of the zoom unit LZ. The image pickup apparatus 125 also includes a lens unit IE that can be inserted into and removed from the optical path between the lens unit R1 and the lens unit R2. By inserting the lens unit IE, a focal length range of the zoom lens 101 can be changed.

Reference numerals 114 and 115 denote drive mechanisms that drive the first lens unit F and the zoom unit LZ in the optical axis direction, respectively. Reference numerals 116 to 118 denote drive units including actuators that drive the drive mechanisms 114 and 115 and the aperture stop SP. Reference numerals 119 to 121 denote detectors for detecting the position of the focus subgroup on the optical axis, the position of the zoom unit LZ on the optical axis, and the aperture diameter of the aperture stop SP. In the camera body 124, reference numeral 109 denotes a glass block including an optical filter, etc., and reference numeral 110 denotes an image sensor such as a CCD sensor or CMOS sensor configured to photoelectrically convert (captures) an object image formed by the zoom lens 101. Reference numerals 111 and 122 denote CPUs that serve as processing units (control units) in the camera body 124 and the zoom lens 101, respectively.

Using the zoom lens according to any one of the above example as an imaging optical system can provide an image with good image quality across the entire zoom range with a wide angle of view and a high zoom ratio.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a zoom lens having a wide angle of view, a high zoom ratio, and high optical performance over the entire zoom range.

This application claims priority to Japanese Patent Application No. 2023-207367, which was filed on Dec. 8, 2023, and which is hereby incorporated by reference herein in its entirety.

What is claimed is:

1. A zoom lens comprising, in order from an object side to an image side:
a first lens unit having positive refractive power that does not move during zooming;
an intermediate group including at least three lens units that move during zooming; and
a final lens unit having positive refractive power that does not move during zooming,
wherein a distance between adjacent lens units changes during zooming,
wherein the intermediate group includes at least one lens unit having negative refractive power,
wherein a lens unit having negative refractive power and closest to an object among the at least one lens unit having negative refractive power includes at least one negative lens, and
wherein the following inequalities are satisfied:
$$2.02 \leq nn \leq 2 \text{.30}$$
$$20. \leq vn \leq 4 0.$$
$$1.5 \leq f 1 / fw \leq 7. 7$$
where nn is a refractive index for d-line of a negative lens closest to the object among the at least one negative lens, vn is an Abbe number based on the d-line of the negative lens closest to the object, fl is a focal length of the first lens unit, and fw is a focal length of the zoom lens at a wide-angle end.

2. The zoom lens according to claim 1, wherein the following inequality is satisfied:
$$0.7 \leq fn / fV \leq 2.0$$
where fn is a focal length of the negative lens closest to the object, and fV is a focal length of the lens unit having negative refractive power and closest to the object.

3. The zoom lens according to claim 1, wherein the following inequality is satisfied:
$$0.63 \leq θ n + 0.00162 \times vn \leq 0.7$$
where θn is a partial dispersion ratio of the negative lens closest to the object for g-line and F-line.

4. The zoom lens according to claim 1, wherein the negative lens closest to the object is an aspheric lens.

5. The zoom lens according to claim 1, wherein the lens unit having negative refractive power and closest to the object includes at least four lenses.

6. The zoom lens according to claim 1, wherein the following inequality is satisfied:
60≤v≤100
where v is an Abbe number based on the d-line of the at least one negative lens.

7. The zoom lens according to claim 1, wherein the following inequality is satisfied:
$$- 0.0040 \leq ( θ {p}_{ave} - θ {n}_{ave} ) / ( {vp}_{ave} - {vn}_{ave} ) < 0.0000$$
where vpₐᵥₑ is an average value of Abbe numbers based on the d-line of at least one positive lens included in the lens unit having negative refractive power and closest to the object, θpₐᵥₑ is an average value of partial dispersion ratios for g-line and F-line of the at least one positive lens, vnₐᵥₑ is an average value of Abbe numbers based on the d-line of the at least one negative lens, and θnₐᵥₑ is an average value of partial dispersion ratios for the g-line and F-line of the at least one negative lens.

8. The zoom lens according to claim 1, wherein the following inequality is satisfied:
$$- 5 \text{.5} \leq fV / fw \leq - 0.3$$
where fV is a focal length of the lens unit having negative refractive power and closest to the object.

9. The zoom lens according to claim 1, wherein a part of the first lens unit moves for focusing.

10. An image pickup apparatus comprising:
a zoom lens; and
an image sensor configured to capture an object image through the zoom lens,
wherein the zoom lens includes, in order from an object side to an image side:
a first lens unit having positive refractive power that does not move during zooming;
an intermediate group including at least three lens units that move during zooming; and
a final lens unit having positive refractive power that does not move during zooming,
wherein a distance between adjacent lens units changes during zooming,
wherein the intermediate group includes at least one lens unit having negative refractive power,
wherein a lens unit having negative refractive power and closest to an object among the at least one lens unit having negative refractive power includes at least one negative lens, and
wherein the following inequalities are satisfied:
$$2.02 \leq nn \leq 2 \text{.30}$$
$$20. \leq vn \leq 4 0.$$
$$1.5 \leq f 1 / fw \leq 7. 7$$
where nn is a refractive index for d-line of a negative lens closest to the object among the at least one negative lens, vn is an Abbe number based on the d-line of the negative lens closest to the object, fl is a focal length of the first lens unit, and fw is a focal length of the zoom lens at a wide-angle end.

11. The image pickup apparatus according to claim 10, wherein the following inequality is satisfied:
$$0. 2 \leq f w / IS \leq 2.2$$
where IS is a diagonal length of an effective imaging surface of the image sensor.
